(19) United States
(12) Patent Application Publication
(10) Pub. No.: US 2002/0071628 A1
(43) Pub. Date: Jun. 13, 2002

(54) Planar waveguide optical switching system with integrated multi-state outputs

(76) Inventors: De Yu Zang, Irvine, CA (US); Xinhong Wang, San Diego, CA (US); Yi Liang, San Diego, CA (US); Jin-Yi Pan, San Diego, CA (US)

Correspondence Address: Lee Hsu, Brobeck , Phleger & Harrison LLP, 12390 EI Camino Real, San Diego, CA, 92130, US

(21) Appl. No.: 09/733,206

(22) Filed: Dec. 7, 2000

(51) Int. Cl. G02B 6/35

(52) U.S. Cl. 385/17; 385/16

(57) ABSTRACT

A thermal optical switching system has two optical outputs from each of the thermal optical switches in the last column of an optical switch matrix to switch the optical outputs between an on state, an off state and a split power state.

### BACKGROUND OF THE INVENTION

1. Field of the Invention

The present invention relates to optical switching systems, and more particularly, to thermal optical switching system applications in optical networks.

2. Background Art

Optical switches, which perform various functions including wavelength routing, optical add-drop multiplexing and system protection, are core components of modern optical communications networks. Conventional planar waveguide thermal optical switches are an important type of optical switches currently employed in optical networking systems. Conventional thermal optical switches typically possess significant advantages of compactness, mass producibility, and cost effectiveness. Because of these advantages, conventional planar waveguide thermal optical switches have been widely employed in optical networking systems, particularly in dense wavelength division multiplexing (DWDM) systems.

FIG. 1 shows a typical plan view of a conventional planar waveguide thermal optical switch with two waveguide inputs A and B and two waveguide outputs A′ and B′. Two optical waveguides 2 and 4 run through an input 3 dB coupler section 6, a switching section 8 and an output 3 dB coupler section 10. The optical waveguides 2 and 4 run close together at the 3 dB coupler sections 6 and 10 and relatively far apart at the switching section 8 to form a Mach-Zehnder interferometer (MZI). An electric heater 12 is implemented along the switching section 8 of the first waveguide 2.

An input optical signal received at the optical input A can be switched to either the optical output A′ or the optical output B′ depending upon the voltage applied to the electric heater 12. If an input optical signal received at the optical input A is transmitted to the optical output A′, the thermal optical switch is said to be in a “bar state.” If the optical signal received at the optical input A is transmitted to the optical output B′, the thermal optical switch is said to be in a “cross state.”

In some types of thermal optical switches, an additional electric heater 14 is implemented along the switching section 8 of the second optical waveguide 4. This type of thermal optical switch is capable of receiving an optical signal at the optical input B and transmitting the signal to either the optical output A′ or the optical output B′, depending upon the voltage applied to the electric heater 14. If the optical signal received at the optical input B is transmitted to the optical output B′, the switch is said to be in a bar state. On the other hand, if the optical signal received at the optical input B is transmitted to the optical output A′, the switch is said to be in a cross state. The optical paths through the thermal optical switch as shown in FIG. 1A are schematically illustrated in FIG. 1B. In FIG. 1B, the optical paths for the cross-states are shown as solid lines whereas the optical paths for the bar states are shown as dashed lines.

FIG. 1C shows a typical plot of optical power versus electrical power applied to one of the electric heaters in the conventional thermal optical switch of FIG. 1A. The optical power illustrated in FIG. 1C is the measured power at the optical output A′ transmitted from the optical input A (in the bar state) or the optical input B (in the cross state) In a typical application, only one of the optical inputs A and B in FIG. 1A receives an input optical signal at a given time, and only one of the electric heaters 12 and 14 is powered by a control voltage to switch the input optical signal to either one of the optical outputs A′ and B′. For example, when the optical input A is connected to receive an input optical signal, the electric heater 12 is applied either a cross-state voltage or a bar-state voltage to switch the input optical signal to either the optical output B′ or the optical output A′, respectively, while the electric heater 14 along the second optical waveguide 4 is inactive.

Referring to FIG. 1C, the electrical power in the horizontal axis is the electrical power applied to the electric heater which controls the switching operation for the input optical signal. When the electrical power applied to the heater 12 is P_{cross}, the optical switch is in a cross state, thereby resulting in an optical signal being switched from the optical input A of the first waveguide 2 to the optical output B′ of the second waveguide 4. When the electrical power applied to the electric heater 12 is P_{bar}, the optical signal received at the optical input A is transferred to the optical output A′ along the same optical waveguide 2.

The vertical axis in FIG. 1C represents the optical power at the output A′ in response to the electrical power applied to the electric heater 12. A conventional driver supplies a control voltage, which is either a cross-state voltage corresponding to the cross state or a bar-state voltage corresponding to the bar state, to the electric heater. The thermal optical switch as shown in FIG. 1A thus performs binary switching operations to transmit the optical signal to either one of the optical outputs A′ and B′, depending upon whether it is in a bar state or a cross state.

Based on the 2×2 thermal optical switch shown in FIG. 1A, larger sized switches can be formed by implementing array or matrix architectures. FIG. 2 shows a diagram of a conventional 4×4 optical switch matrix having a plurality of columns of thermal optical switches 20a, 20b, . . . 20d, 22a, 22b, . . . 22h, 24a, 24b, . . . 24h and 26a, 26b, . . . 26d. The thermal optical switches 20a, 20b, 20c and 20d in the first column are connected to optical inputs 28a, 28b, 28c and 28d, respectively. For each of the thermal optical switches 20a, 20b, 20c and 20d in the first column, only one of the two optical inputs is connected to receive input optical signals while the other is inactive. Similarly, for each of the thermal optical switches 26a, 26b, 26c and 26d in the last column, only one of the optical outputs is used for outputting a switched optical signal from the optical switch matrix. Such a conventional optical switch matrix can provide strictly non-blocking switch functions. In a typical configuration, all of the thermal optical switches and waveguide connections between the thermal optical switches as shown in FIG. 2 are implemented on a single substrate 30.

### SUMMARY OF THE INVENTION

The present invention provides an optical switching system, generally comprising:

a plurality of optical inputs;

a plurality of optical outputs arranged in pairs, each of the optical outputs capable of being switched to an on state, an off state, or a split power state; and

a plurality of optical switches arranged in a plurality of columns including first and last columns, the optical switches in the first column connected to the optical inputs, each of the optical switches in the last column connected to a respective pair of the optical outputs.

Advantageously, the optical switching system in an embodiment according to the present invention is capable of not only switching optical signals between on and off states but also outputting optical signals at a desired optical power level in a controlled manner. Furthermore, the optical switching system in an embodiment according to the present invention has two active optical outputs from each of the optical switches in the last column to allow the additional outputs to be used in an optical fiber communications network, thereby increasing the flexibility of optical signal traffic in the optical fiber communications network.

### BRIEF DESCRIPTION OF THE DRAWINGS

The present invention will be described with particular embodiments thereof, and references will be made to the drawings in which:

FIG. 1A, described above, shows a simplified plan view of a conventional thermal optical switch;

FIG. 1B, described above, shows a schematic diagram illustrating the bar state and the cross state for the thermal optical switch of FIG. 1A;

FIG. 1C, described above, shows a typical plot of optical power at one of the optical outputs versus the electrical power applied to one of the electric heaters in the thermal optical switch of FIG. 1A;

FIG. 2, described above, shows a conventional thermal optical switching system with one active optical output from each of the thermal optical switches in the last column;

FIG. 3 shows an embodiment of a thermal optical switching system with multi-state outputs according to the present invention; and

FIG. 4 shows a plot of optical power versus electrical power illustrating a split power state between the cross state and the bar state.

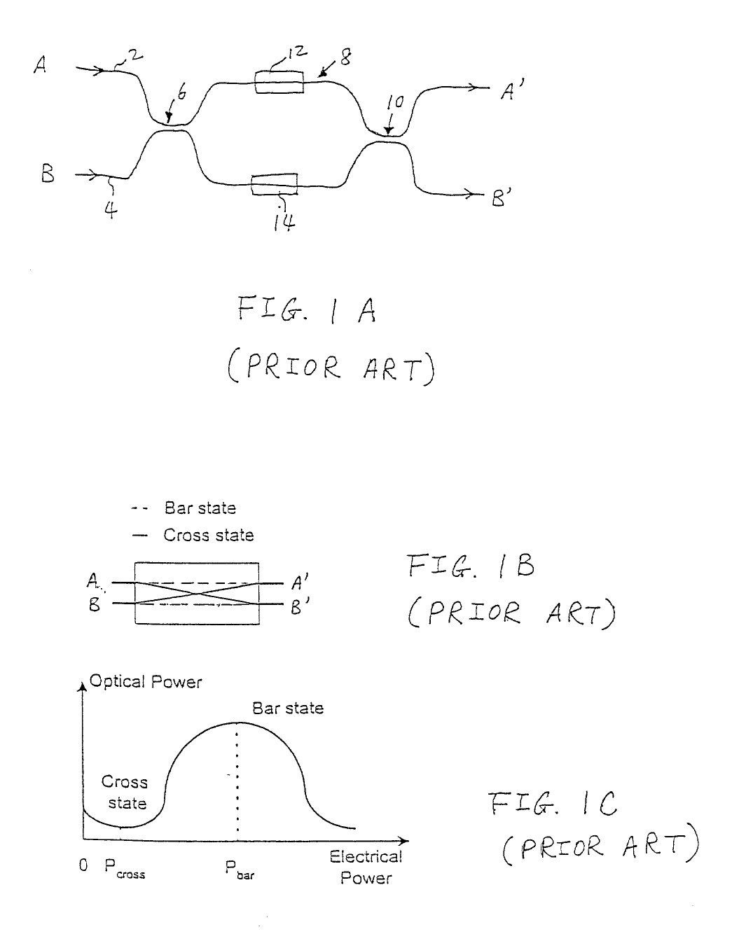

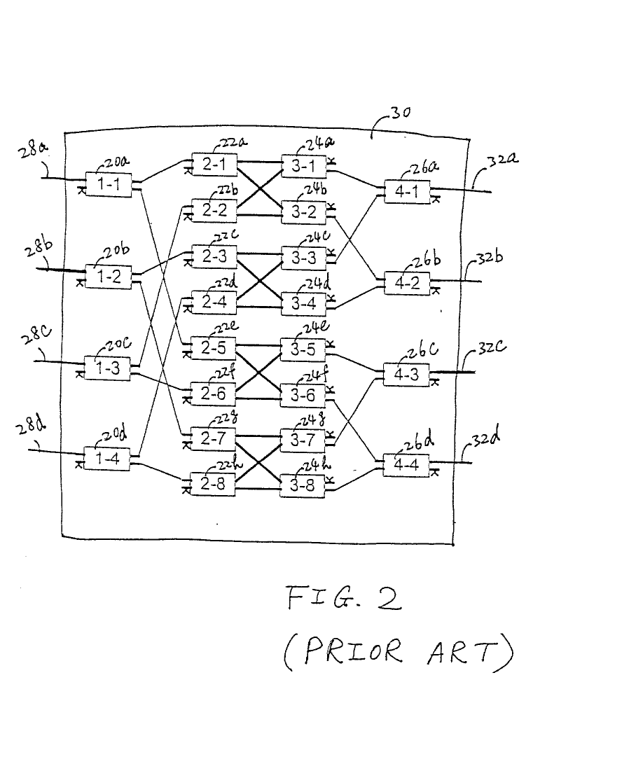

### DETAILED DESCRIPTION

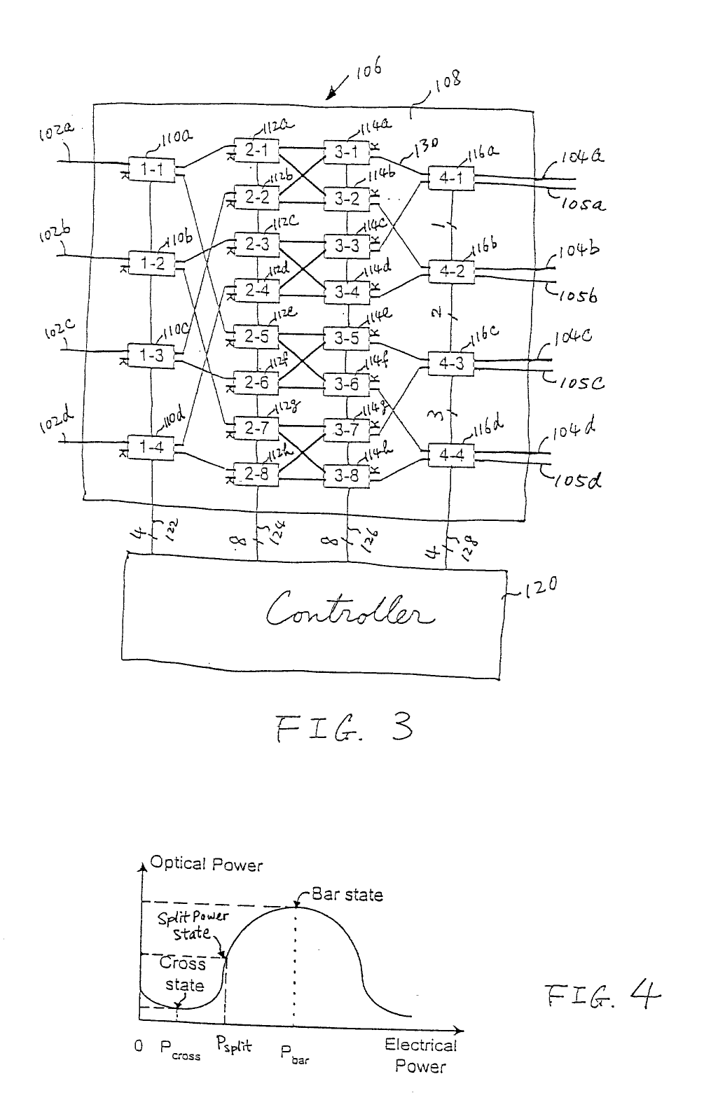

FIG. 3 shows an embodiment of a thermal optical switching system with integrated multi-state outputs in accordance with the present invention. In this embodiment, the thermal optical switching system has eight optical inputs 102a, 102b, 102c and 102d and four optical outputs 104a, 105a, 104b, 105b, 104c, 105c, 104d and 105d arranged in four pairs. The thermal optical switching system includes an optical switch matrix 106 integrated monolithically on a single substrate 108. In the embodiment shown in FIG. 3, the optical switch matrix 106 includes four columns of integrated thermal optical switches 110a, 110b, 110c, 110d, 112a, 112b, 112c, . . . 112h, 114a, 114b, 114c, . . . 114h, and 116a, 116b, 116c and 116d. The optical paths between the thermal optical switches are provided by planar waveguides with crossovers on the substrate 108 in a conventional manner apparent to a person skilled in the art.

The thermal optical switches 110a, 10b, 110c and 110d in the first column are connected to the optical inputs 102a, 102b, 102c and 102d, respectively. In the embodiment shown in FIG. 3, for each of the thermal optical switches l10a, 10b, 110c and 110d in the first column, only one of the two optical inputs is connected to receive an input optical signal while the other is inactive. The thermal optical switches 116a, 116b, 116c and 116d in the last column each have two optical outputs. The optical switch 116a has two optical outputs 104a and 105a, the optical switch 116b has two optical outputs 104b and 105b, the optical switch 116c has two optical outputs 104c and 105c, while the optical switch 116d has two optical outputs 104d and 105d.

The cross connections of the optical waveguides in the substrate 108 between different columns of optical switches in the optical switch matrix 106 are similar to the cross connections of waveguides in the conventional optical switching system as shown in FIG. 2, which is described above. Other arrangements of waveguide cross connections between the thermal optical switches can also be contemplated within the scope of the present invention. Furthermore, although an embodiment of the present invention is described with reference to a 4×4 integrated thermal optical switch matrix as shown in FIG. 3, optical switch matrices of various sizes with other optical routing arrangements are also within the scope of the present invention.

In the embodiment shown in FIG. 3, a controller 120 is connected to the thermal optical switches in the optical switch matrix 106. In an embodiment, a separate control voltage is supplied to each of the thermal optical switches in the optical switch matrix 106 through one of the voltage lines such as voltage lines 122, 124, 126 and 128. In an embodiment, each of the thermal optical switches 116a, 116b, 116c and 116d in the last column of the thermal optical switch matrix 106 is controlled by a respective control voltage generated by the controller 120 to switch the optical outputs between an on state, an off state and a split power state. Depending on the control voltage applied to a given one of the thermal optical switches in the last column, the two optical outputs of the thermal optical switch are either in complementary on and off states or in the split power state.

FIG. 4 shows a plot of optical power versus electrical power of a given one of the thermal optical switches 116a, 116b, 116c and 116d in the last column of the thermal optical switch matrix 106 as shown in FIG. 3. In FIG. 4, the bar state corresponds to an on state for a first one of the two optical output of the given thermal optical switch in the last column of the matrix and an off state for the second optical output of the same thermal optical switch. Conversely, the cross state corresponds to an off state for the first optical output of the given thermal optical switch in the last column of the matrix and an on state for the second optical output of the same thermal optical switch.

Between the bar state and the cross state is a split power state in which some of the output optical power is transferred to the first optical output and some of the optical power is transferred to the second optical output of the thermal optical switch in the last column of the matrix. Referring to FIG. 3, for example, when the thermal optical switch 116a with an optical signal present at input 130 is switched to a bar state, its first optical output 104a is in the on state while its second optical output 105a is in the off state. Conversely, when the thermal optical switch 116a is switched to a cross state, the first optical output 104a is in the off state while the second optical output 105a is in the on state. The bar state voltage and the cross state voltage applied to the thermal optical switch 116a correspond to the electrical power P_{bar} and P_{cross} supplied to the electric heater in the thermal optical switch 116a respectively to switch the optical outputs 104a and 105a between complimentary on and off states.

When an intermediate state voltage is applied by the controller 120 to the thermal optical switch 116a, the electric heater in the thermal optical switch 116a is supplied with electrical power Pₛₚₗᵢₜ to set the optical outputs 104a and 105a in a split power state. In the split power state, a percentage of the input optical power received by the thermal optical switch 116a is transferred to the first optical output 104a while another percentage of the input power is transferred to the second optical output 105a.

In an embodiment, the split power state is a half power state in which substantially equal optical power is transferred to the optical outputs 104a and 105a in response to a control voltage which is an intermediary voltage between the bar-state voltage and the cross-state voltage. The optical power versus electrical power curve of FIG. 4 depends upon the type of thermal optical switch used, the design parameters and process variations. The intermediary voltage for switching the optical outputs to the half power state may or may not be the average of the cross-state voltage and the bar-state voltage.

The optical power versus electrical power curve can be measured for a given thermal optical switch in a conventional manner known to a person skilled in the art. With known characteristics of the optical power versus electrical power curve, the controller 120 in FIG. 3 can be programmed to generate control voltages to drive the thermal optical switches 116a, 116b, 116c and 116d in the last column of the thermal optical switch matrix 106 between the on state, the off state and the split power state.

Although an embodiment of the present invention is described with reference to a 4×4 integrated thermal optical switch matrix as shown in FIG. 3 with four columns of thermal optical switches, optical switch matrices of various sizes with multi-state outputs can also be contemplated within the scope of the present invention. Furthermore, the split power state in various embodiments according to the present invention is not limited to the half power state in which the two optical outputs of a given thermal optical switch in the last column of the matrix transmit substantially equal optical power. For example, in some applications it may be desirable to have a power split of 60% to 40% or 70% to 30% between the first and second optical outputs of a given thermal optical switch instead of a 50% to 50% power split.

The present invention has been described with respect to particular embodiments thereof, and numerous modifications can be made which are within the scope of the invention as set forth in the claims.

What is claimed is:

1. An optical switching system, comprising:
a plurality of optical inputs;
a plurality of optical outputs arranged in pairs, each of the optical outputs capable of being switched to an on state, an off state, or a split power state; and
a plurality of optical switches arranged in a plurality of columns including first and last columns, the optical switches in the first column connected to the optical inputs, each of the optical switches in the last column connected to a respective pair of the optical outputs.

2. The system of claim 1, wherein the optical switches in the last column are capable of being controlled by respective control voltages to switch the optical outputs between the on state, the off state and the split power state.

3. The system of claim 1, further comprising a controller connected to the optical switches in at least one of the columns.

4. The system of claim 3, wherein the controller is connected to supply control voltages to the optical switches in the last column, the control voltages each being variable over a range of voltages including a bar-state voltage corresponding to the on state for a first one of the respective pair of optical outputs and the off state for a second one of the respective pair of optical outputs, a cross-state voltage corresponding to the off state for the first one of the respective pair of optical outputs and the on state for the second one of the respective pair of optical outputs, and an intermediate-state voltage corresponding to the split power state for the respective pair of optical outputs.

5. The system of claim 1, wherein the split power state is a half power state, wherein each of the optical switches in the last column is capable of outputting substantially equal optical power to the respective pair of optical outputs in response to a control voltage which is between a bar-state voltage and a cross-state voltage, the bar-state voltage corresponding to the on state for a first one of the respective pair of optical outputs and the off state for a second one of the respective pair of optical outputs, the cross-state voltage corresponding to the off state for the first one of the respective pair of optical outputs and the on state for the second one of the respective pair of optical outputs.

6. The system of claim 1, wherein the optical switches are arranged in first, second, third and fourth columns, the first column comprising four optical switches connected to the optical inputs, the second column comprising eight optical switches connected to the optical switches in the first column, the third column comprising eight optical switches connected to the optical switches in the second column, the fourth column comprising four optical switches connected between the optical switches in the third column and the optical outputs.

7. The system of claim 1, wherein the optical switches comprise thermal optical switches.

8. The system of claim 7, wherein the thermal optical switches comprises integrated thermal optical switches.

9. A thermal optical switching system, comprising:
a plurality of optical inputs;
a plurality of optical outputs arranged in pairs, each pair of the optical outputs capable of being switched to either complementary on and off states or a half power state; and
a plurality of thermal optical switches arranged in a plurality of columns including first and last columns, the thermal optical switches in the first column connected to the optical inputs, each of the thermal optical switches in the last column connected to a respective pair of the optical outputs.

10. The system of claim 9, wherein the thermal optical switches in the last column are capable of being controlled by respective control voltages to switch the optical outputs between the on state, the off state and the half power state.

11. The system of claim 10, further comprising a controller connected to supply the control voltages to the thermal optical switches in the last column, the control voltages each being variable over a range of voltages including a bar-state voltage corresponding to the on state for a first one of the respective pair of optical outputs and the off state for a second one of the respective pair of optical outputs, a cross-state voltage corresponding to the off state for the first one of the respective pair of optical outputs and the on state for the second one of the respective pair of optical outputs, and an intermediate-state voltage corresponding to the half power state for the respective pair of optical outputs.

12. The system of claim 9, wherein the thermal optical switches are arranged in first, second, third and fourth columns, the first column comprising four thermal optical switches connected to the optical inputs, the second column comprising eight thermal optical switches connected to the thermal optical switches in the first column, the third column comprising eight thermal optical switches connected to the thermal optical switches in the second column, the fourth column comprising four thermal optical switches connected between the thermal optical switches in the third column and the optical outputs.

13. A thermal optical switching system, comprising:
a plurality of optical inputs;
a plurality of optical outputs arranged in pairs, each pair of the optical outputs capable of being switched to either complementary on and off states or a split power state;
a plurality of thermal optical switches arranged in a plurality of columns including first and last columns, the thermal optical switches in the first column connected to the optical inputs, each of the thermal optical switches in the last column connected to a respective pair of the optical outputs; and
a controller connected to supply respective control voltages to the thermal optical switches in the last column, the control voltages each being variable over a range of voltages including a bar-state voltage corresponding to the on state for a first one of the respective pair of optical outputs and the off state for a second one of the respective pair of optical outputs, a cross-state voltage corresponding to the off state for the first one of the respective pair of optical outputs and the on state for the second one of the respective pair of optical outputs, and an intermediate-state voltage corresponding to the split power state for the respective pair of optical outputs.

14. The system of claim 13, wherein the thermal optical switches are arranged in first, second, third and fourth columns, the first column comprising four thermal optical switches connected to the optical inputs, the second column comprising eight thermal optical switches connected to the thermal optical switches in the first column, the third column comprising eight thermal optical switches connected to the thermal optical switches in the second column, the fourth column comprising four thermal optical switches connected between the thermal optical switches in the third column and the optical outputs.

15. The system of claim 13, wherein the split power state is a half power state, wherein each of the thermal optical switches in the last column is capable of outputting substantially equal optical power to the respective pair of optical outputs in response to the intermediate voltage.

16. A thermal optical switching system, comprising:
a plurality of optical inputs;
a plurality of optical outputs arranged in pairs to output optical power received at the optical inputs; and
means for switching each of the optical outputs between an on state, an off state and a split power state.

17. The system of claim 16, wherein the means for switching each of the optical outputs comprises a plurality of thermal optical switches arranged in a plurality of columns including a last column, each of the thermal optical switches in the last column connected to a respective pair of the optical outputs.

18. The system of claim 17, wherein the thermal optical switches in the last column are capable of being controlled by respective control voltages to switch the optical outputs between the on state, the off state and the split power state.

19. The system of claim 17, wherein the means for switching each of the optical outputs further comprises a controller connected to the thermal optical switches in at least one of the columns.

20. The system of claim 19, wherein the controller is connected to supply control voltages to the thermal optical switches in the last column, the control voltages each being variable over a range of voltages including a bar-state voltage corresponding to the on state for a first one of the respective pair of optical outputs and the off state for a second one of the respective pair of optical outputs, a cross-state voltage corresponding to the off state for the first one of the respective pair of optical outputs and the on state for the second one of the respective pair of optical outputs, and an intermediate-state voltage corresponding to the split power state for the respective pair of optical outputs.

21. The system of claim 20, wherein the split power state is a half power state, wherein each of the thermal optical switches in the last column is capable of outputting substantially equal optical power to the respective pair of optical outputs.

22. The system of claim 17, wherein the thermal optical switches are arranged in first, second, third and fourth columns, the first column comprising four thermal optical switches connected to the optical inputs, the second column comprising eight thermal optical switches connected to the thermal optical switches in the first column, the third column comprising eight thermal optical switches connected to the thermal optical switches in the second column, the fourth column comprising four thermal optical switches connected between the thermal optical switches in the third column and the optical outputs.

23. A method of switching optical signals in an optical switch system having a plurality of optical switches arranged in a plurality of columns including a last column, the method comprising the steps of:
supplying a control voltage to at least one of the optical switches in the last column, said at least one optical switch in the last column having a first output and a second output, the control voltage being variable between a bar-state voltage, a cross-state voltage, and an intermediate-state voltage between the bar-state voltage and the cross-state voltage, to switch the first and second inputs of said at least one optical switch in the last column between a bar state, a cross state, and a split power state.

24. The method of claim 23, wherein the optical switches comprise thermal optical switches.

25. The method of claim 23, wherein the split power state is a half power state, wherein the first and second outputs of said at least one optical switch in the last column output substantially equal optical power.
